(19) United States
(12) Patent Application Publication
(10) Pub. No.: US 2010/0257979 A1
(43) Pub. Date: Oct. 14, 2010

(54) Open End Ratchet Wrench

(76) Inventor: Shu-Su ZHAN, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/422,259

(22) Filed: Apr. 11, 2009

(51) Int. Cl. B25B 13/46; B25B 13/00

(52) U.S. Cl. 81/58.2; 81/61

(57) ABSTRACT

An open end ratchet wrench is defined with a gap which allows the ratchet wrench to pass through a pipe or obstacle to carry out rotation, thus improving the operability and convenience of the wrench. Both ends of the open end ratchet wrench extend outward to form a stopping piece, respectively. The stopping pieces allow the toothed pawl to be well positioned and prevent it from disengaging, thus maintaining a stable torque and making the ratchet wrench easy to use.

### BACKGROUND OF THE INVENTION

1. Field of the Invention

The present invention relates to a hand tool, and more particularly to an open end ratchet wrench.

2. Description of the Prior Art

Hand tools are indispensible to many works, take the wrench as an example, an open end wrench is easy to use since it can be used to rotate a fastener directly by passing though barrier. In many situations, however, the user has to repeatedly attach the wrench to the fastener to be rotated, take it off and then attach it again to the fastener, in order continue the rotation of the fastener. Hence, a ratchet wrench appeared, which is rotatable in a unidirectional manner, so that the user can keep turning the wrench without taking it off the fastener, and thus the ratchet wrench is much improved in operability. However, in some situations, during the assembly of a cooler pipeline for example, the fastener maybe located at the end of the pipeline, so it cannot be rotated by a ratchet wrench without disassembling the pipeline and conventionally, it can only be screwed or unscrewed by an open end wrench. Hence, the author of the invention made an open end ratchet wrench.

### SUMMARY OF THE INVENTION

The primary object of the present invention is to provide an open end ratchet wrench which can be inserted on pipe directly via its gap, so that its operability and convenience are much improved.

To achieve the above object, the open end ratchet wrench comprises a head portion, a ratchet and at least one ratchet. The head portion is defined with head portion defined with a receiving hole, a receiving chamber in the receiving hole, and a gap defined in a periphery edge of the head portion. The ratchet is rotatably received in the head portion, an inner surface of the ratchet serves as a work area, the ratchet is provided on its outer periphery with a plurality of teeth and a gap to be aligned with the gap of the head portion. The toothed pawl is received in the receiving chamber of the head portion and provided with a plurality of teeth for meshing with the teeth of the ratchet, one end of the toothed pawl extends outward to form a stopping piece which is shaped corresponding to an outer periphery of the ratchet. By such arrangements, the ratchet wrench provides a better operability and convenience. Furthermore, the stopping piece makes the ratchet rotate smoothly in the receiving hole of the body of the wrench, thus improving the torque performance of the open end ratchet wrench.

### BRIEF DESCRIPTION OF THE DRAWINGS

FIG. 1 is a perspective view of an open end ratchet wrench in accordance with the present invention;

FIG. 2 is an exploded view of the open end ratchet wrench in accordance with the present invention;

FIG. 3 is a cross sectional view of the open end ratchet wrench in accordance with the present invention;

FIG. 4 is an operational view of the open end ratchet wrench in accordance with the present invention;

FIG. 5 is another cross sectional view of the open end ratchet wrench in accordance with the present invention;

FIG. 6 shows that the ratchet is being adjusted by rotating the rotary member;

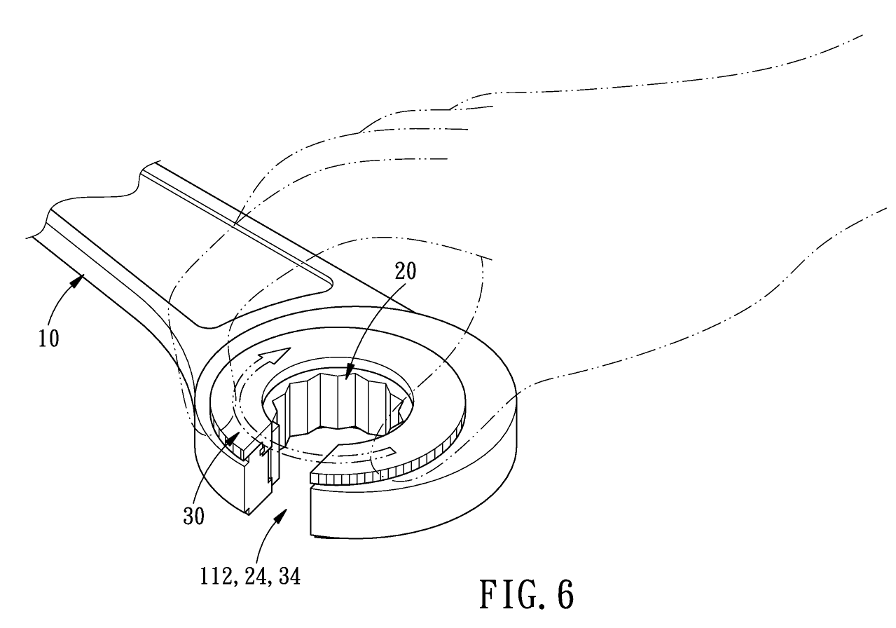

FIG. 7 is a cross sectional view of a bidirectional open end ratchet wrench in accordance with the present invention; and

FIG. 8 shows that the bidirectional open end ratchet wrench in accordance with the present invention is provided with two toothed pawl.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

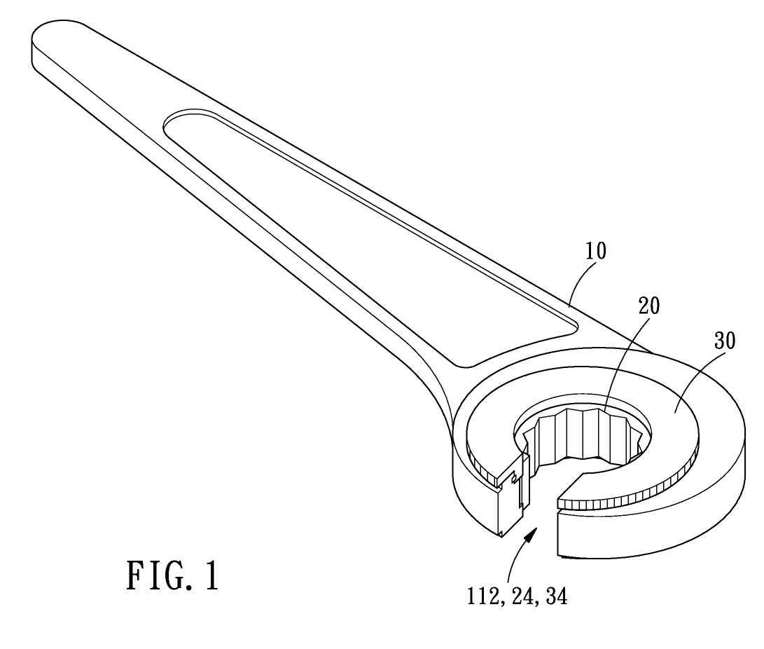

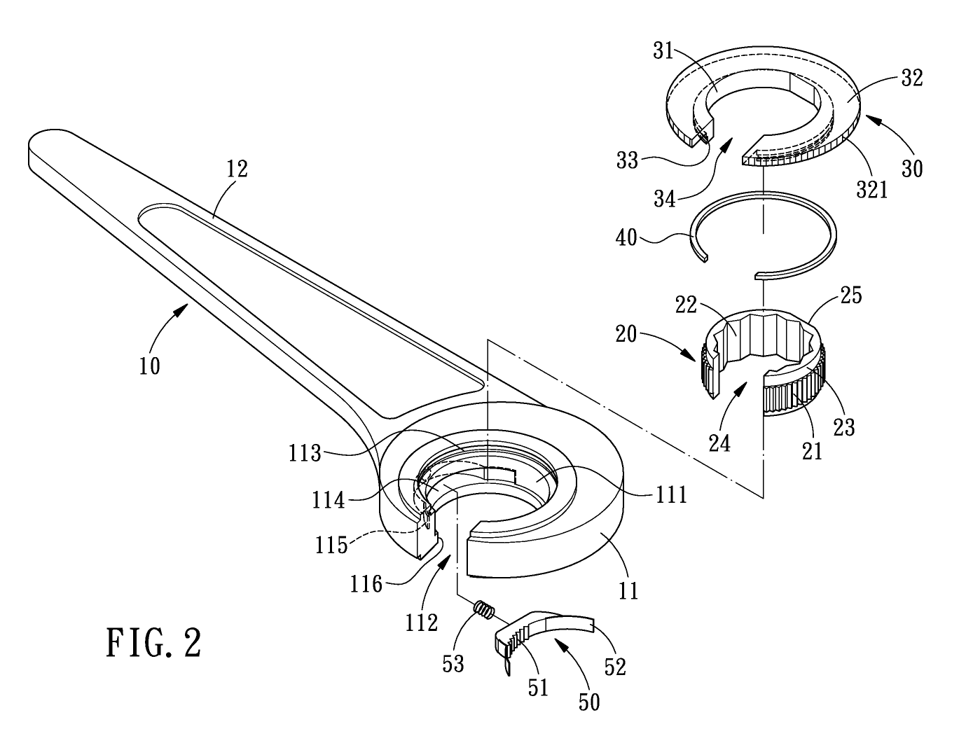

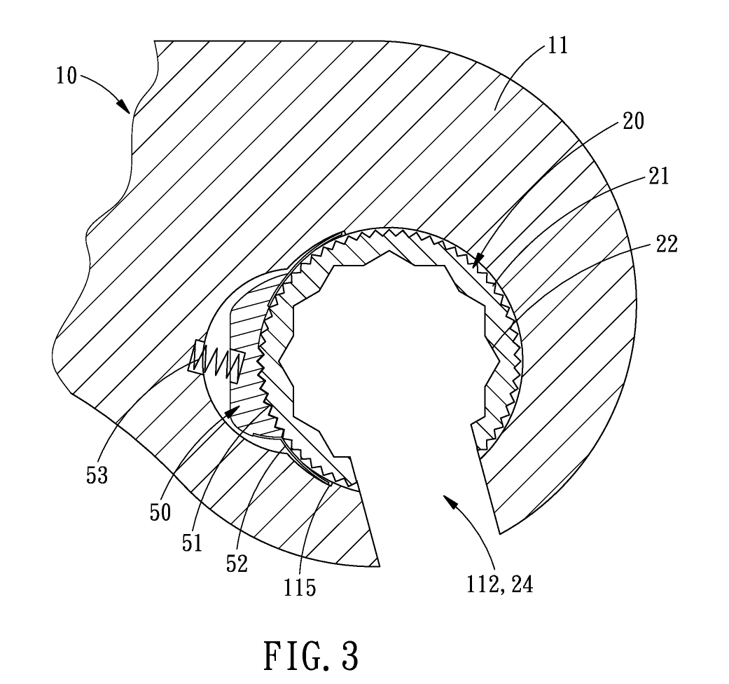

Referring to FIGS. 1-3, an open end ratchet wrench in accordance with a preferred embodiment of the present invention comprises: a body 10, ratchet 20, a rotary member 30, a C-shaped retainer 40 and a toothed pawl 50.

The body 10 comprises a head portion 11 and a handle portion 12. The head portion 11 is defined with a circular receiving hole 111 and a gap 112 formed in the periphery edge of the head portion 11, so that the head portion 11 is C-shaped. In the receiving hole 111 is formed an annular groove 113, and in the inner periphery of the receiving hole 111 close to the handle portion 12 is further defined a crescent-shaped receiving chamber 114 and a restriction recess 115 formed at each of both sides of the receiving chamber 114. On a side of the receiving chamber 114 opposite the annular groove 113 is further formed a flange 116.

The ratchet 20 is rotatably received in the receiving groove 111 of the head portion 11 and abutted against the flange 116 which restricts the ratchet 20 in the receiving groove 111. The ratchet 20 is C-shaped and provided with a plurality of teeth 21 on its outer surface, and the inner surface of the ratchet 20 is a work area 22 for engaging with a tool or fastener. One end of the ratchet 20 extends outward to form a first joint portion 23. A gap 24 is formed in the periphery of the ratchet 20 and can be aligned with the gap 112 of the head portion 11, and the ratchet 20 is further defined with a non-circular engaging portion 25.

The rotary member 30 is provided with a second joint portion 31, a disc-shaped portion 32 connected to the second joint portion 31, and an annular groove 33 defined between the second joint portion 31 and the disc-shaped portion 32. The second joint portion 31 is engaged with the first joint portion 23 of the ratchet 20 and restricted by the engaging portion 25, so that the disc-shaped portion 32 can synchronously drive the ratchet 20 to rotate. The disc-shaped portion 32 protrudes out of the head portion 11 of the body 10 and is provided on its outer periphery with an anti-skid portion 321 which can be in the form of irregular embossing or ribs. The rotary member 30 is further defined with a gap 34 to be aligned with the gaps 112 and 24.

The C-shaped retainer 40 is clamped in the annular groove 33 of the rotary member 30, and after the rotary member 30 is jointed to the ratchet 20, the C-shaped retainer 40 is expanded outwards and pressed against the inner surface of the annular groove 113 of the head portion 11.

The toothed pawl 50 is received in the receiving chamber 114 of the head portion 11 of the body 10 and provided on its surface facing the ratchet 20 with a plurality of teeth 51 for meshing with the teeth 21 of the ratchet 20 and for allowing the ratchet 20 to rotate only in a unidirectional manner. Both ends of the toothed pawl 50 extend to form a stopping piece 52, respectively. The stopping pieces 52 are arc-shaped corresponding to the outer periphery of the ratchet 20, and the total length of the toothed pawl 50 including the stopping pieces 52 is longer than the length of each of the gaps 112 and 24. When the toothed pawl 50 is received in the receiving chamber 114, the stopping pieces 52 are restricted in the restriction recess 115, and an elastic member 53 is abutted against the toothed pawl 50 and the bottom of the receiving chamber 114 to make the toothed pawl 50 move elastically in the receiving chamber 114.

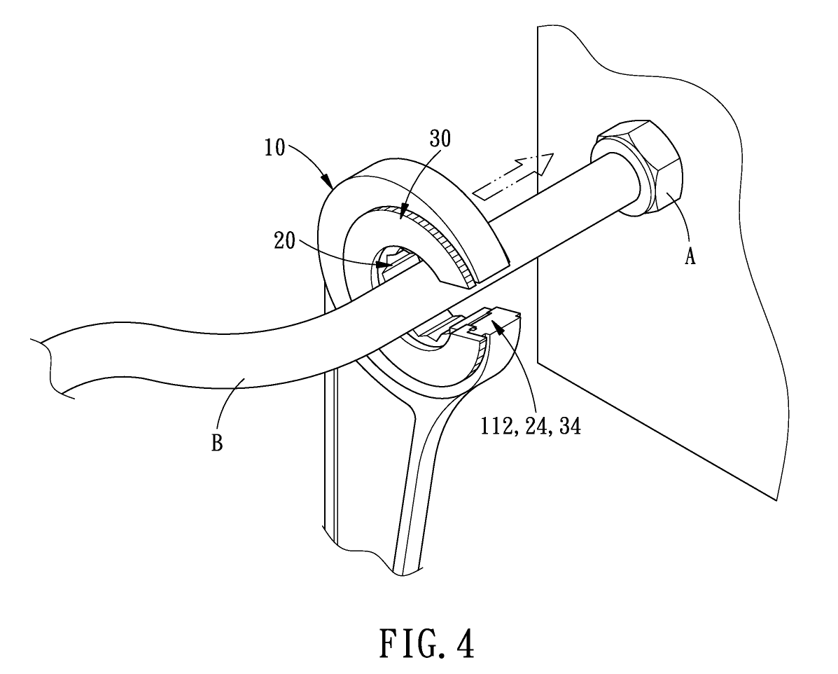

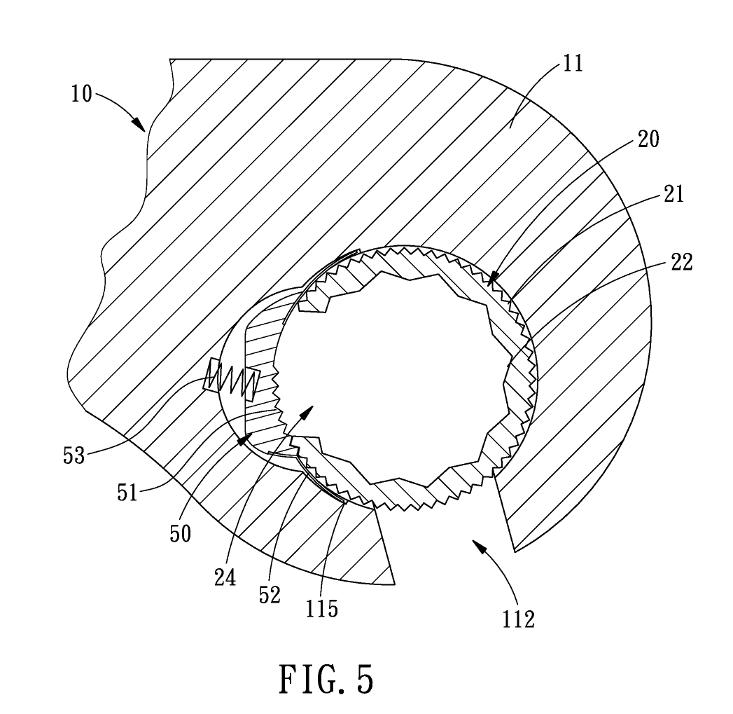

As shown in FIG. 4, when a fastener A is located at the end of a pipeline B, with the gaps 112 and 24, the head portion of the open end ratchet of the present invention can be inserted on the pipeline B, so that the fastener A can be rotated without disassembling the pipeline B. In the use of the ratchet wrench, when the gap 24 of the ratchet 20 is rotated to the position of the toothed pawl 50, as shown in FIG. 5, the stopping pieces 52 of the toothed pawl 50 will make the ratchet 20 keep abutting against the toothed pawl 50 without being affected by the gap 24 or the receiving chamber 114, making the ratchet 20 rotate smoothly without seizing up, and meanwhile, preventing the torque value of the wrench from being influenced.

After the use of the open end ratchet wrench, the gaps 24 and 112 might not be aligned, and at this moment, rotating the rotary member 30 to cause the rotation of the ratchet 20 can make the gaps 24 and 112 aligned. Since the rotary member 30 protrudes out of the head portion 11 and is provided on its outer periphery with the anti-skid portion 321, the disc-shaped portion 32 is easy to grip.

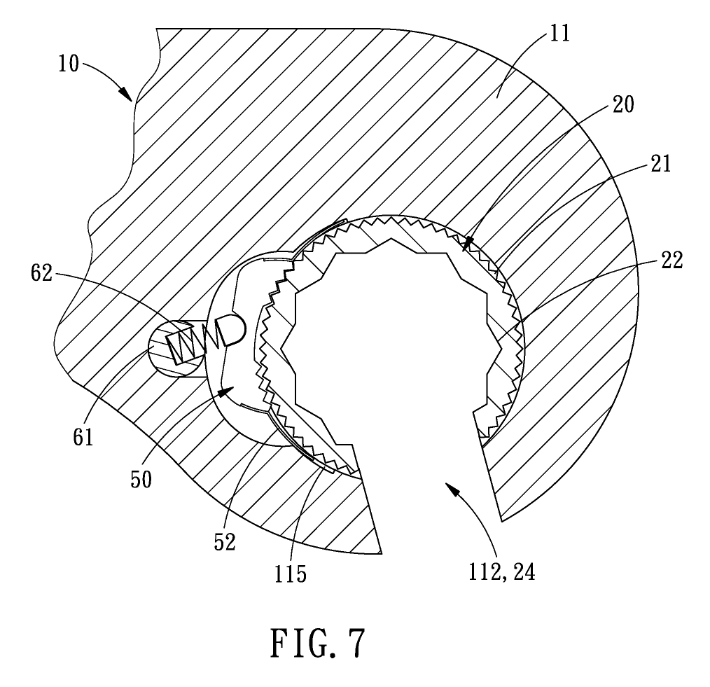

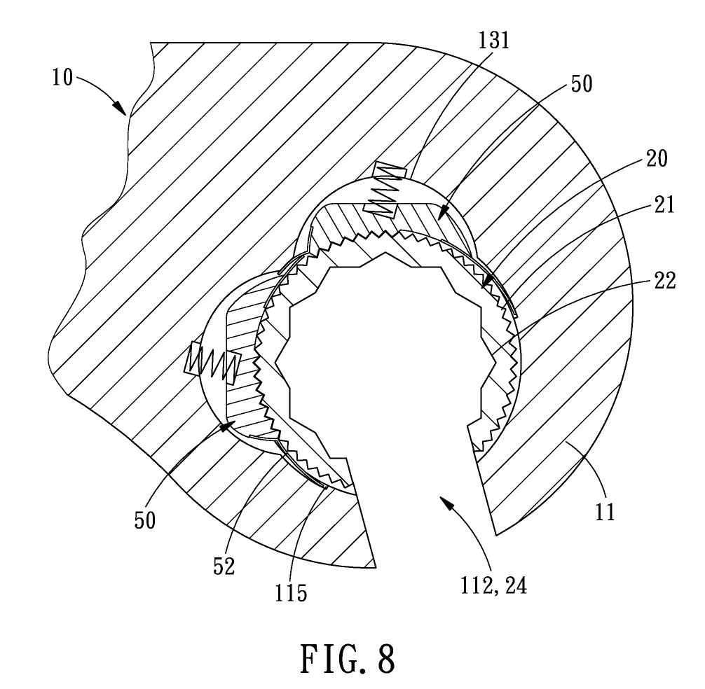

The above embodiment is a unidirectional ratchet wrench as an example, but it can also be a bidirectional ratchet wrench, as shown in FIG. 7, each of the stopping pieces 52 of the toothed pawl 50 is provided with a plurality of teeth 51 in such a manner that the angular direction of the teeth 51 of one stopping piece 52 is reversed to that of the teeth 51 of the other stopping piece 52. The bidirectional ratchet wrench is further provided with a diverter member 61 and an elastic member 62. The diverter member 61 is engaged with the toothed pawl 50 and drives it to swing, and the elastic member 62 serves to push the toothed pawl 50 back to its original position. The diverter member 61 can change the direction of the force applied by the ratchet 20 and improve the operability and convenience of the open end ratchet wrench. In addition, the head portion 11 can further be provided with another receiving chamber 114 in which is disposed another toothed pawl 50, as shown in FIG. 8, so as to provide more engaging points for the ratchet 20, improving the torque performance of the open end ratchet wrench.

While we have shown and described various embodiments in accordance with the present invention, it is clear to those skilled in the art that further embodiments may be made without departing from the scope of the present invention.

What is claimed is:

1. An open end ratchet wrench comprising:
a head portion defined with a receiving hole, a receiving chamber in the receiving hole, and a gap defined in a periphery edge of the head portion, a toothed pawl being disposed in the receiving chamber;
a ratchet rotatably received in the head portion, an inner surface of the ratchet serving as a work area, the ratchet being provided on its outer periphery with a with a plurality of teeth and a gap to be aligned with the gap of the head portion; and
a toothed pawl received in the receiving chamber of the head portion and provided with a plurality of teeth for meshing with the teeth of the ratchet, one end of the toothed pawl extending outward to form a stopping piece which is shaped corresponding to an outer periphery of the ratchet.

2. The open end ratchet wrench as claimed in claim 1, wherein the ratchet is C-shaped and disposed in the receiving chamber of the head portion.

3. The open end ratchet wrench as claimed in claim 1, wherein both ends of the toothed pawl extend outward to form a stopping piece, respectively.

4. The open end ratchet wrench as claimed in claim 1 further comprising a rotary member which is provided with a second joint portion and a disc-shaped portion connected to the second joint portion, the ratchet comprises a first joint portion, the second joint portion is engaged with the first joint portion of the ratchet, the disc-shaped portion synchronously drives the ratchet to rotate, the disc-shaped portion protrudes out of the head portion of the body and is provided on its outer periphery with an anti-skid portion which is in the form of irregular embossing or ribs.

5. The open end ratchet wrench as claimed in claim 1 further comprising a C-shaped retainer, wherein an annular groove is defined in the receiving chamber of the receiving hole of the head portion, an annular groove defined between the second joint portion and the disc-shaped portion, the C-shaped retainer is clamped in the annular groove of the rotary member and expanded outwards and pressed against an inner surface of the annular groove of the head portion, on a side of the receiving chamber opposite the annular groove of the head portion is further formed a flange against which one end of the ratchet is positioned.

6. The open end ratchet wrench as claimed in claim 1 further comprising a handle portion connected to the head portion, the receiving chamber is formed in an inner periphery of the receiving hole close to the handle portion.

7. The open end ratchet wrench as claimed in claim 1 further comprising a diverter device which is provided with a diverter member and an elastic member, the diverter member is engaged with the toothed pawl and drives it to swing, and the elastic member of the diverter device serves to push the toothed pawl back to its original position, turning the diverter member can change an operation direction of the ratchet, each of both ends of the toothed pawl is provided with a plurality of teeth in such a manner that an angular direction of the teeth of one end of the toothed pawl is reversed to that of the teeth at the other end of the toothed pawl.

8. The open end ratchet wrench as claimed in claim 1, wherein the receiving hole of the head portion is defined with two receiving chambers for reception of two toothed pawl.

9. The open end ratchet wrench as claimed in claim 1 further comprising an elastic member abutted against the toothed pawl and a bottom of the receiving chamber to make the toothed pawl move elastically in the receiving chamber.

10. A toothed pawl of an open end ratchet wrench being provided with a plurality of teeth, one end of the toothed pawl close to the teeth extending outward to form at least one stopping piece which is shaped corresponding to an outer periphery of the ratchet.

11. The toothed pawl of an open end ratchet wrench as claimed in claim 10 comprising a ratchet, the teeth of the toothed pawl are meshed with the ratchet, and the side of the toothed pawl with the teeth is arc-shaped.

12. The toothed pawl of an open end ratchet wrench as claimed in claim 11, wherein both ends of the toothed pawl extend outward to form a stopping piece, respectively.

13. An open end ratchet wrench for matching the toothed pawl of an open end ratchet wrench as claimed in claim 12, comprising:
a head portion defined with a receiving hole, a receiving chamber in the receiving hole, and a gap defined in a periphery edge of the head portion, a toothed pawl being disposed in the receiving chamber;
a ratchet rotatably received in the head portion, an inner surface of the ratchet serving as a work area, the ratchet being provided on its outer periphery with a with a plurality of teeth and a gap to be aligned with the gap of the head portion.

14. The open end ratchet wrench as claimed in claim 13, wherein the ratchet is C-shaped and disposed in the receiving chamber of the head portion.

15. The open end ratchet wrench as claimed in claim 13 comprises a rotary member which is provided with a second joint portion and a disc-shaped portion connected to the second joint portion, the ratchet comprises a first joint portion, the second joint portion is engaged with the first joint portion of the ratchet, the disc-shaped portion synchronously drives the ratchet to rotate, the disc-shaped portion protrudes out of the head portion of the body and is provided on its outer periphery with an anti-skid portion which is in the form of irregular embossing or ribs.

16. The open end ratchet wrench as claimed in claim 13 comprises a C-shaped retainer, wherein an annular groove is defined in the receiving chamber of the receiving hole of the head portion, an annular groove defined between the second joint portion and the disc-shaped portion, the C-shaped retainer is clamped in the annular groove of the rotary member and expanded outwards and pressed against an inner surface of the annular groove of the head portion, on a side of the receiving chamber opposite the annular groove of the head portion is further formed a flange against which one end of the ratchet is positioned.

17. The open end ratchet wrench as claimed in claim 13 comprises a handle portion connected to the head portion, the receiving chamber is formed in an inner periphery of the receiving hole close to the handle portion.

18. The open end ratchet wrench as claimed in claim 13 comprises a diverter device which is provided with a diverter member and an elastic member, the diverter member is engaged with the toothed pawl and drives it to swing, and the elastic member of the diverter device serves to push the toothed pawl back to its original position, turning the diverter member can change an operation direction of the ratchet, each of both ends of the toothed pawl is provided with a plurality of teeth in such a manner that an angular direction of the teeth of one end of the toothed pawl is reversed to that of the teeth at the other end of the toothed pawl.

19. The open end ratchet wrench as claimed in claim 13, wherein the receiving hole of the head portion is defined with two receiving chambers for reception of two toothed pawl.

20. The open end ratchet wrench as claimed in claim 13 comprises an elastic member abutted against the toothed pawl and a bottom of the receiving chamber to make the toothed pawl move elastically in the receiving chamber.
